(19) United States
(12) Patent Application Publication
(10) Pub. No.: US 2025/0070507 A1
(43) Pub. Date: Feb. 27, 2025

(54) HIGH-SPEED CONNECTOR SYSTEM

(71) Applicant: Molex, LLC, Lisle, IL (US)

(72) Inventors: Francois André Jean Cullard, Trappes (FR); Bruno Dessirier, St. Germaine en Laye (FR)

(21) Appl. No.: 18/729,182

(22) PCT Filed: Jan. 26, 2023
(86) PCT No.: PCT/IB2023/050693

§ 371 Date: Jul. 16, 2024

Related U.S. Application Data
(60) Provisional application No. 63/304,966, filed on Jan. 31, 2022.

(51) Int. Cl. H01R 13/631; H01R 13/627

(52) U.S. Cl. CPC H01R 13/6315; H01R 13/6272

(57) ABSTRACT

A high-speed connector system includes a male connector and a female connector which are configured to be coupled together. Each connector includes a housing and a module. Each housing houses a plurality of electrical terminals in terminal receiving passageways and has walls defining a module receiving passage in which the module is seated. Each module is configured to receive an electrical terminal, and has a plurality of rounded nubs on walls forming the module which are engaged with walls forming the module receiving passage. The nubs space the module from the walls of the module receiving passage and form a ball joint to allow floating of the module relative to the housing.

### RELATED APPLICATIONS

This application claims priority to U.S. Provisional Application No. 63/304,966 filed Jan. 31, 2022, which is incorporated herein by reference.

### FIELD OF THE DISCLOSURE

This disclosure relates to a high-speed connector system having a male connector with a male module mounted therein by a ball joint, and a female connector having a female connector with a female module mounted therein by a ball joint. The ball joints allow the modules to float relative to the connectors in order to properly align the connectors during mating.

### DESCRIPTION OF RELATED ART

High-speed connector systems include a male connector having a male module, and a female connector having a female module. During mating, the modules may misalign, which prevents a proper mating of the terminals within the modules. As a result of the foregoing, certain individuals would appreciate further improvements in such apparatuses and the operation of same.

### BRIEF SUMMARY

Accordingly, in an embodiment, the present disclosure provides a high-speed connector system which includes a male connector and a female connector that are configured to be coupled together. Each connector includes a housing and a module. Each housing houses a plurality of electrical terminals in terminal receiving passageways and has walls defining a module receiving passage in which the module is seated. Each module is configured to receive an electrical terminal, and has a plurality of rounded nubs on walls forming the module which are engaged with walls forming the module receiving passage. The nubs space the module from the walls of the module receiving passage and form a ball joint to allow the module to float relative to the housing.

### BRIEF DESCRIPTION OF THE DRAWINGS

The present disclosure is illustrated by way of example, and not limited, in the accompanying figures in which like reference numerals indicate similar elements and in which:

FIG. 1 depicts a perspective view of a connector system having a male connector and a female connector, with the female connector being viewed from the rear, and with the connectors in a pre-lock position;

FIG. 2 depicts a perspective view of the connector system, with the female connector being viewed from the rear, and with the connectors in a locked position:

FIG. 3 depicts a front perspective view of a housing of the male connector:

FIG. 4 depicts a front perspective view of the male connector:

FIG. 5 depicts a partial front elevation view of the male connector:

FIG. 6 depicts a rear perspective view of the housing of the male connector:

FIG. 7 depicts a partial rear elevation view of the male connector:

FIG. 8 depicts a cross-sectional view of the male connector:

FIG. 9 depicts a rear exploded perspective view of a female module of the female connector and a male module of the male module:

FIG. 10 depicts a partial front elevation view of the female connector;

FIG. 11 depicts a partial rear elevation view of the female connector;

FIG. 12 depicts a cross-sectional view of the male connector:

FIG. 13 depicts a cross-sectional view of the male and female connectors in the pre-lock position; and

FIG. 14 depicts a cross-sectional view of the male and female connectors in the locked position.

### DETAILED DESCRIPTION OF THE PREFERRED EMBODIMENTS

While the disclosure may be susceptible to embodiment in different forms, there is shown in the drawings, and herein will be described in detail, specific embodiments with the understanding that the present disclosure is to be considered an exemplification of the principles of the disclosure and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

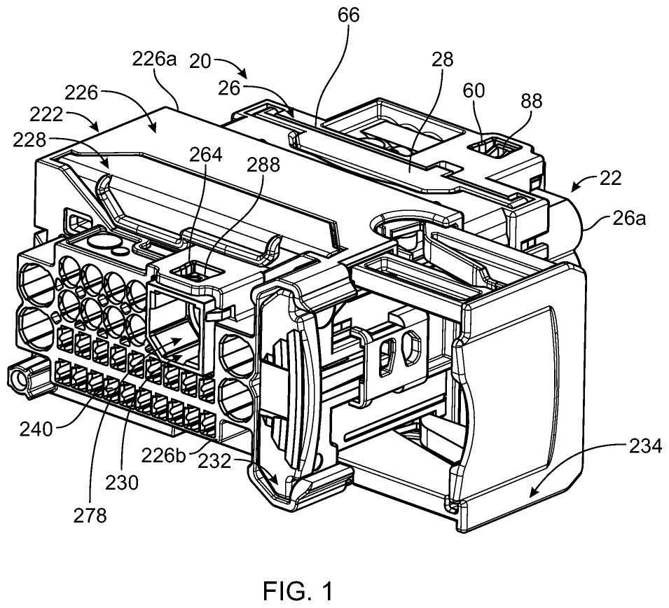

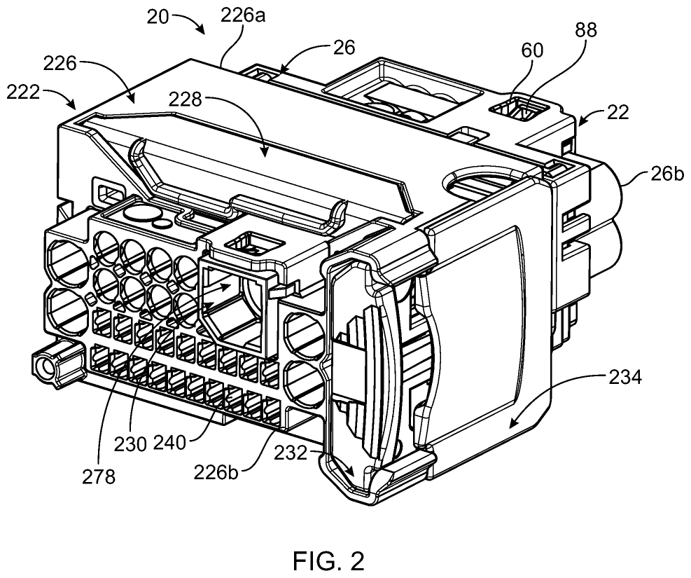

As illustrated in FIGS. 1 and 2, a high-speed connector system 20 includes a male connector 22 and a female connector 222 which are configured to removably mate together. The male connector 22 has a male housing 26, an independent secondary lock 28 movable relative to the male housing 26, and a male module 30, see FIG. 4, removably mounted therein. The independent secondary lock 28 assists in positioning and holding the male module 30 within the male housing 26. The female connector 222 has a female housing 226, an independent secondary lock 228 movable relative to the female housing 226, a female module 230 removably mounted therein, a connector position assurance device 232, and a slider 234. The independent secondary lock 228 assists in positioning and holding the female module 230 within the female housing 226. The modules 30, 230 are configured to mate together during the mating of the male and female connectors 22, 222 to couple mating electrical terminals (not shown) housed within the modules 30, 230. The connector position assurance device 232 and the slider 234 are used to further affix the male and female connectors 22, 222 together and are not described herein.

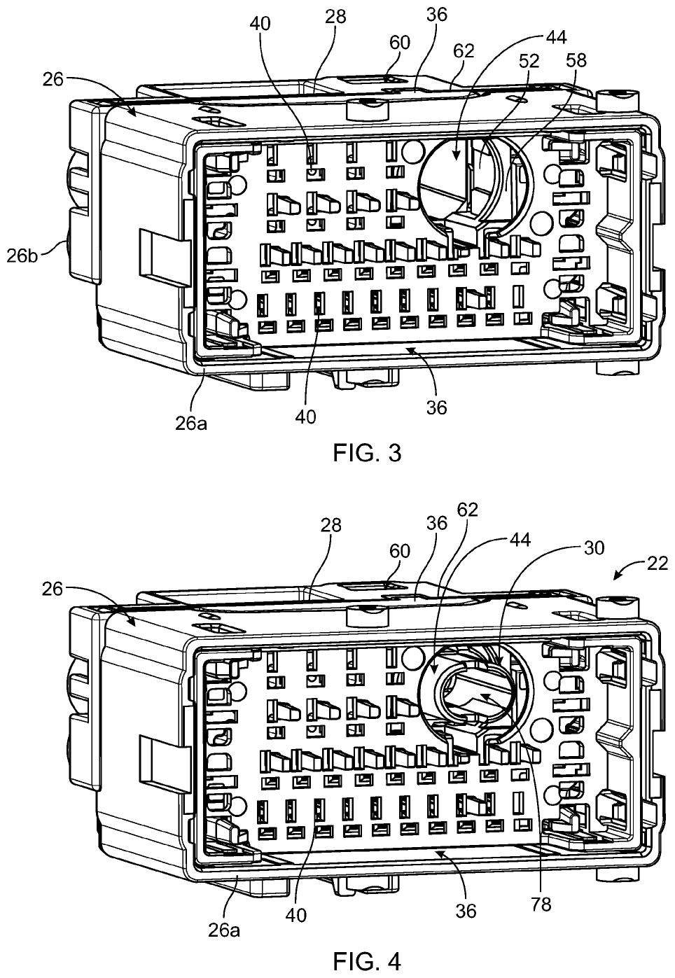

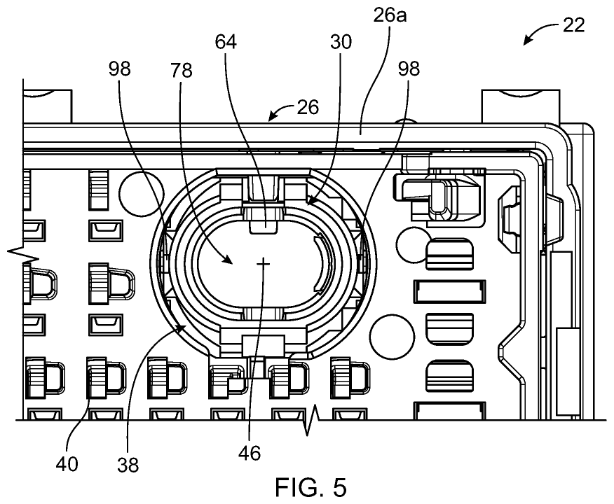

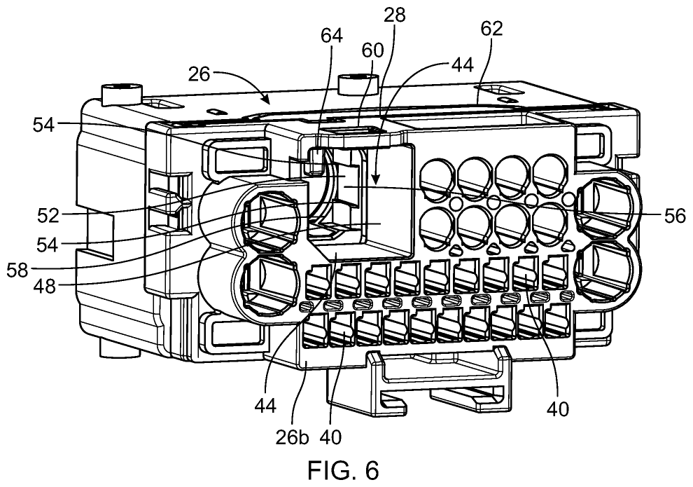

The male connector 22 is best shown in FIGS. 3-7. The male housing 26 is generally formed as a block and has an upper surface, a lower surface and side surfaces connecting the upper and lower surfaces together. The male housing 26 may be formed of multiple parts. A cavity 36 extends from a front end 26a of the male housing 26 to an enlarged male module receiving passage 38 that extends from the cavity 36 to a rear end 26b of the male housing 26 and extends from the front end 26a of the male housing 26 to a plurality of terminal receiving passageways 40 that extend from the cavity 36 to the rear end 26b of the male housing 26. The male module 30 is removably mounted within the male module receiving passage 38. Electrical terminals (not shown) are housed within the terminal receiving passageways 40. The electrical terminals may attach to a wire bundle (not shown) that may connect to wire harness or other electrical components. The terminal receiving passageways 40 may be formed in rows and columns.

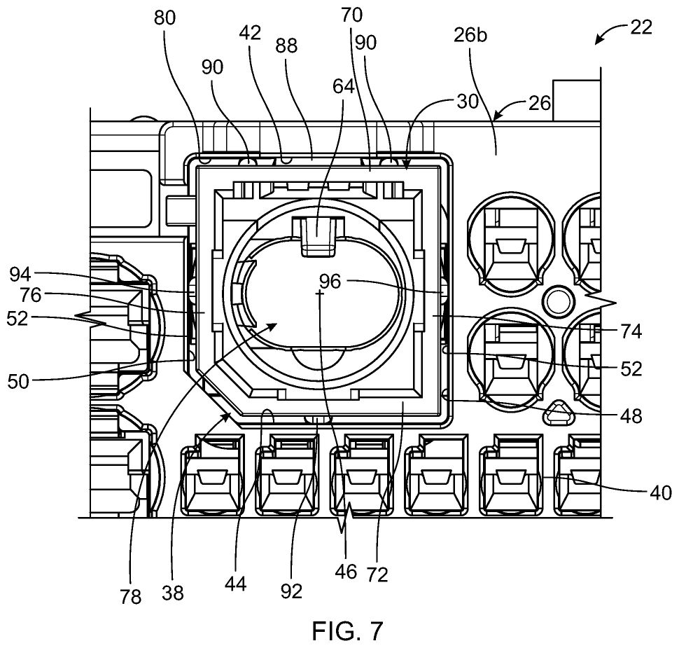

As shown in FIG. 7, the male module receiving passage 38 and has a top wall surface 42, a bottom wall surface 44, and opposite side wall surfaces 48, 50 extending between the top and bottom wall surfaces 42, 44. The top and bottom wall surfaces 42, 44 are parallel to each other, and the side wall surfaces 48, 50 are parallel to each other and are perpendicular to the top and bottom wall surfaces 42, 44. A central axis 46 is defined between front and rear ends of the male module receiving passage 38. A portion of each side wall surface 48, 50 has a recess 52 therein, see FIG. 6, having upper and lower walls 54 which extend perpendicular to the central axis of the male module receiving passage 38 and a planar side wall 56 that extends vertically. The recesses 52 may extend from the front end 26a of the male housing 26. A stop wall 58, see FIG. 6, extends partially into the male module receiving passage 38 at the front end of the male module receiving passage 38 to restrict the size of the male module receiving passage 38. The stop wall 58 is directly forward of the recesses 52.

An opening 60 extends through the male housing 26 from the upper surface thereof, proximate to the rear end 26b thereof, and intersects the male module receiving passage 38. A slot 62 extends through the male housing 26 from the upper surface thereof, and intersects the male module receiving passage 38. The slot 62 is forward of the opening 60.

The independent secondary lock 28 seats within the slot 62 and has an opening which aligns with the male module receiving passage 38 of the male housing 26. The independent secondary lock 28 has a projection 64, see FIGS. 6 and 7, which extends into its opening and is configured to extend into the male module receiving passage 38. The independent secondary lock 28 further has openings which align with the terminal receiving passageways 40 of the male housing 26. Upon movement of the independent secondary lock 28 relative to the male housing 26, the projection 64 moves into the male module receiving passage 38 to engage with and prevent the withdrawal of the male module 30 from the male housing 26, or moves out of male module receiving passage 38 to disengage from and allow the withdrawal of the male module 30 from the male housing 26.

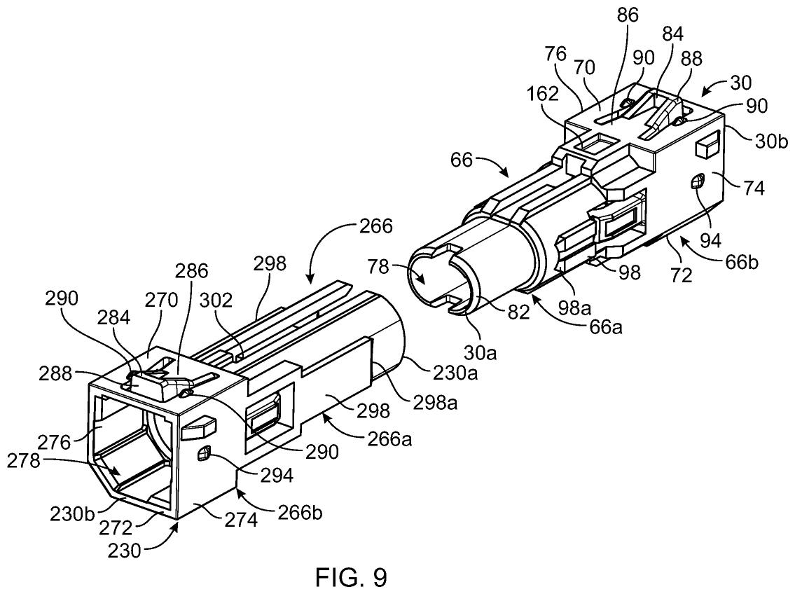

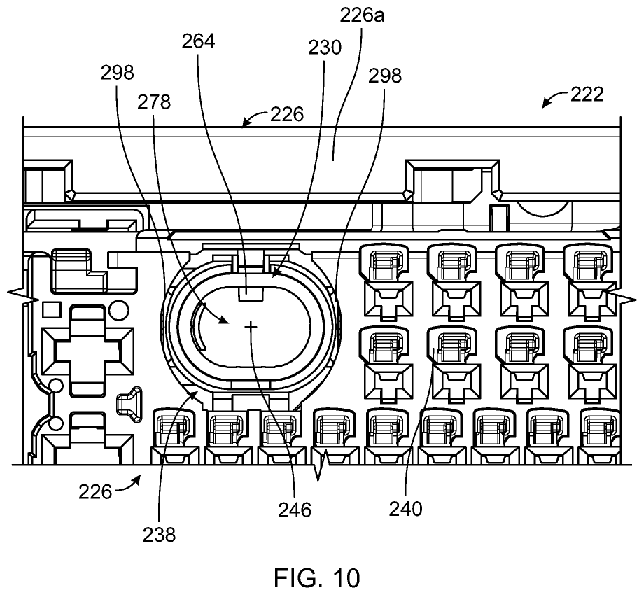

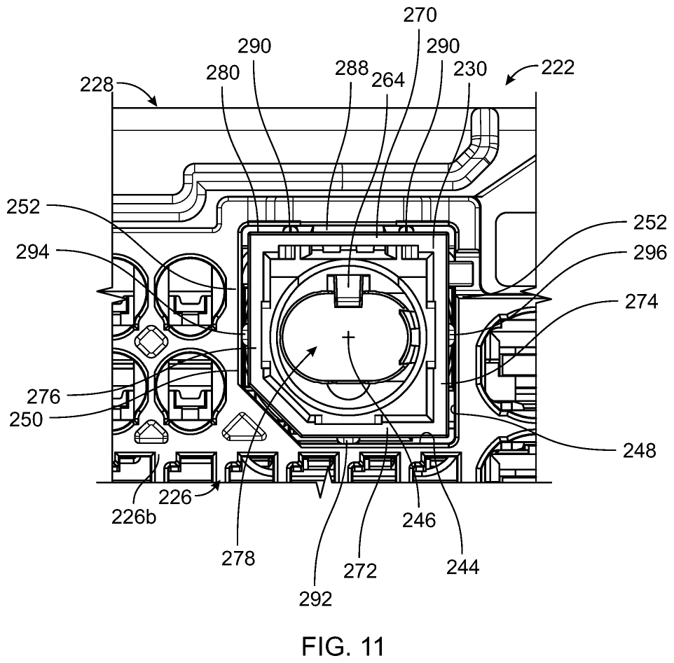

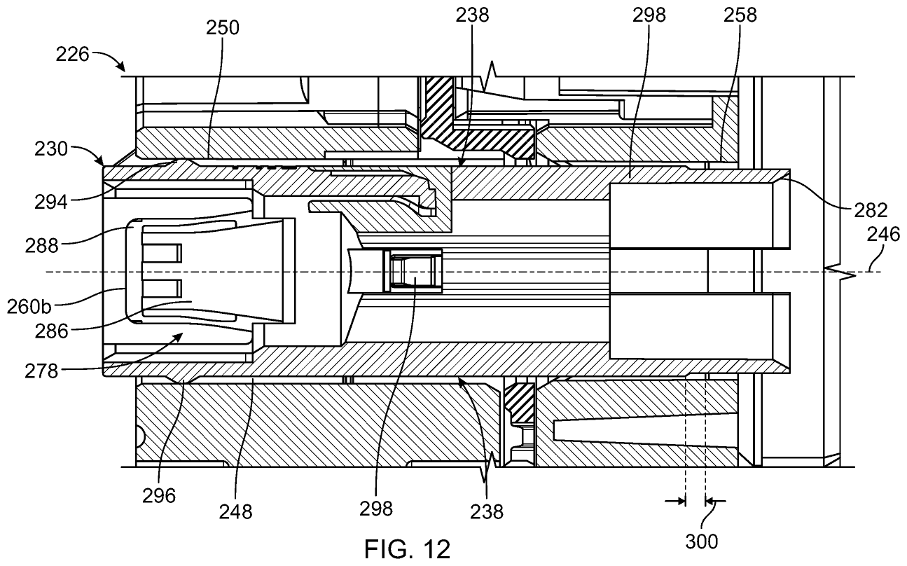

The male module 30 is best shown in FIG. 9. The male module 30 has a housing 66 formed from a top wall 70, an opposite bottom wall 72, and opposite side walls 74, 76 extending therebetween which forms a passageway 78 that extends from a front end 30a thereof to a rear end 30b thereof. The outer profile of the housing 66 may be generally the same shape as the inner profile of the male module receiving passage 38, however, the outer profile of the housing 66 is smaller than the inner profile of the male module receiving passage 38 such that a gap 80, see FIG. 7, is formed completely around the housing 66 between the top wall 70 of the housing 66 and the top wall surface 42 of the male module receiving passage 38, between the bottom wall 72 of the housing 66 and the bottom wall surface 44 of the male module receiving passage 38, between the side wall 74 of the housing 66 and the side wall surface 48 of the male module receiving passage 38, and between the side wall 76 of the housing 66 and the side wall surface 50 of the male module receiving passage 38. In an embodiment and as shown in FIG. 9, a front portion 66a of the housing 66 has an outer profile that is generally cylindrical, and a rear portion 66b of the housing 66 has an outer profile that is generally a rectangular prism. The front end 30a may have a chamfer 82 on its outer surface.

A depressible longitudinally extending latch 84 is formed in the top wall 70. The latch 84 has an elongated arm 86 which is coupled to the top wall 70 at its forward end and an enlarged head 88 at the rear end of the arm 86.

A plurality of rounded nubs 90, 92, 94, 96 which form a ball joint extend from the housing 66. A pair of the nubs 90 extend outward from the outer surface of the top wall 70 proximate to, but spaced from, the rear end 30b; nub 92 extends outward from the outer surface of the bottom wall 72 proximate to, but spaced from, the rear end 30b; nub 94 extends outward from the outer surface of the side wall 74 proximate to, but spaced from, the rear end 30b; and nub 96 extends outward from the outer surface of the side wall 76 proximate to, but spaced from, the rear end 30b. The nubs 90, 92, 94, 96 are longitudinally aligned with each other around the housing 66 and may generally align with the head 88. The nubs 90 are provided on each side of the head 88. Each nub 90, 92, 94, 96 has a rounded outer profile and may form a dome.

Longitudinally extending projections 98 extend outward from the side walls 74, 76 forward of the latch 84. The projections 98 are aligned with each other. Each projections 98 may have a chamfer at the front end thereof to assist in the insertion of the male module 30 into the male housing 26. An opening 102 is provided through the top wall 70 forward of the latch 84 and is used to accommodate the projection 64 of the independent secondary lock 28.

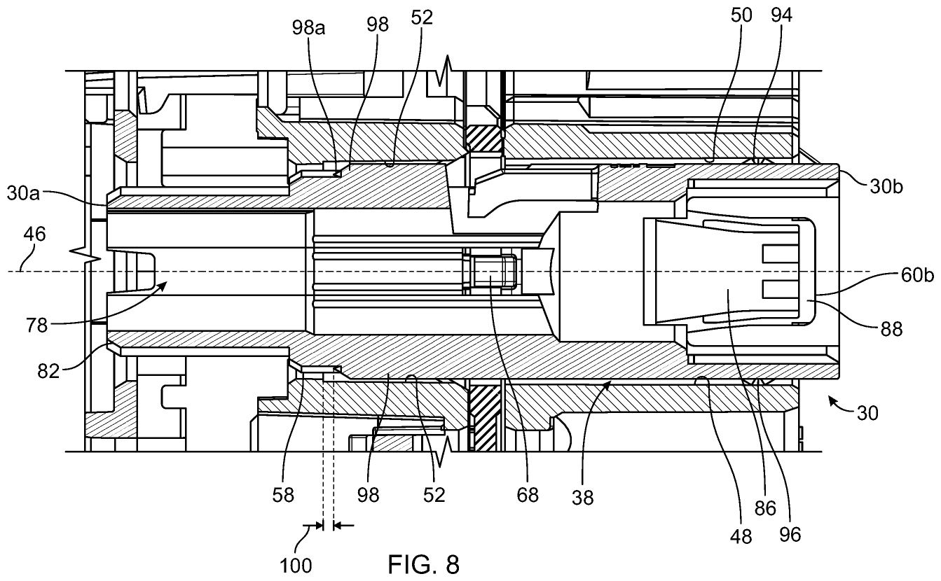

To couple the male module 30 and the male housing 26, the front end 30a of the male module 30 is inserted through the rear end 26b of the male housing 26, and the projections 98 slide along the side wall surfaces 48, 50 and then seat within the recesses 52. Each recess 52 is larger than the respective projection 98, and each projection 98 extends rearward from the respective recess 52 such that the projections 98 can move within the recesses 52. Upon entry into the male housing 26, the head 88 of the latch 84 engages with the top wall surface 42 and flexes the arm 86 to depress the latch 84 slightly into the male module receiving passage 38. The head 88 slides along the top wall surface 42 until the head 88 aligns with the opening 60 which allows the arm 86 to resume its unflexed position and the head 88 can engage with a rear wall 60b of the opening 60. The opening 60 is larger than the head 88. Upon entry into the male housing 26, the nubs 90 slide along the top wall surface 42 of the male module receiving passage 38, the nub 92 slides along the bottom wall surface 44 of the male module receiving passage 38, the nub 94 slides along the side wall surface 48 of the male module receiving passage 38, and the nub 96 slide along the side wall surface 50 of the male module receiving passage 38. Once the head 88 seats within the opening 60, nubs 90 bear against the top wall surface 42, nub 92 bears against the bottom wall surface 44, nub 94 bears against the side wall surface 48, and the nub 96 bears against the side wall surface 50. The front ends 98a of the projections 98 are spaced from the stop wall 58 such that a gap 100, see FIG. 8, is provided therebetween.

The engagement of the nubs 90, 92, 94, 96 with the wall surfaces 42, 44, 48, 50 allows the male module 30 to be centered within the male module receiving passage 38 and to float within the male housing 26 such that the male module 30 can rotate around its central axis relative to the male housing 26. The sizes of the recesses 52 limit the rotation of the front end 30a of the male module 30 relative to the male housing 26 around the central axis by only allowing limited movement of the projections 98 therewithin. The stop wall 58 provides a forward stop for the male module 30 and the rear wall 60b of the opening 60 which the head 88 engages provides a rearward stop for the male module 30.

The female housing 226 and the independent secondary lock 228 of the female connector 222 are formed in a similar manner to that of the male connector 22 (excluding the modifications to the housings 26, 226 that allow for the connector position assurance device 232 and the slider 234 to be coupled to the male and female connectors 22, 222) and like elements are denoted with the same reference numerals except in the two hundreds and three hundreds. The specifics are not repeated herein.

The female module 230 is formed in a like manner to that of the male module 30 and like elements are denoted with the same reference numerals except in the two hundreds and three hundreds. The female module 230 is best shown in FIG. 9. The female module 230 differs from the male module 30 in that the passageway 278 of the female module 230 is larger than the front portion 66a of the male module 30, and that the chamfer 282 is on an outer side of the front portion 66a of the female module 30. Like the male module 30, the engagement of the nubs 290, 292, 294, 296 of the female module 230 with the wall surfaces 242, 244, 248, 250 of the female connector 222 allows the female module 230 to be centered within the female module receiving passage 238 and to float within the female housing 226 such that the female module 230 can rotate around its central axis relative to the female housing 226. The sizes of the recesses 252, including the gap 300, limit the rotation of the front end 230a of the female module 230 relative to the female housing 226 around the central axis by only allowing limited movement of the projections 298 therewithin. The stop wall 258 provides a forward stop for the female module 230 and the rear wall 260b of the opening 260 which the head 288 engages provides a rearward stop for the female module 230.

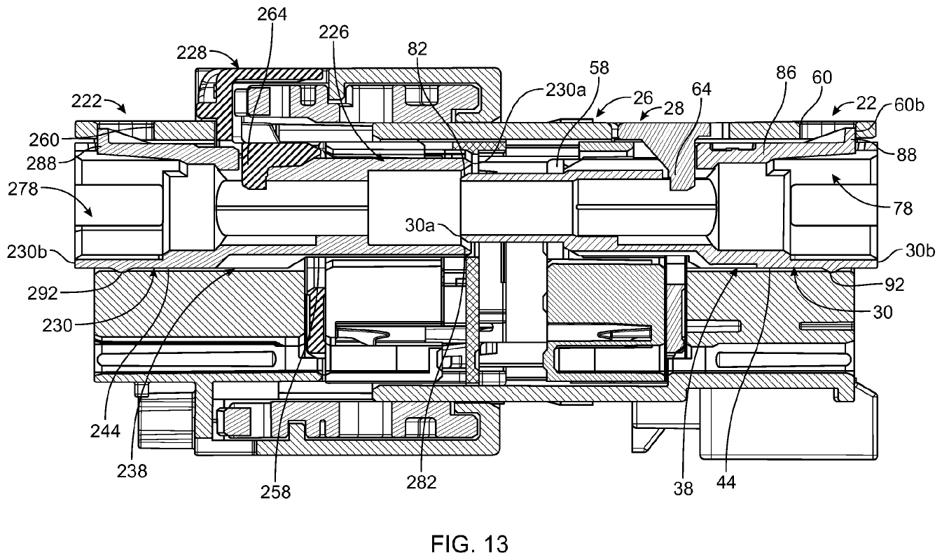

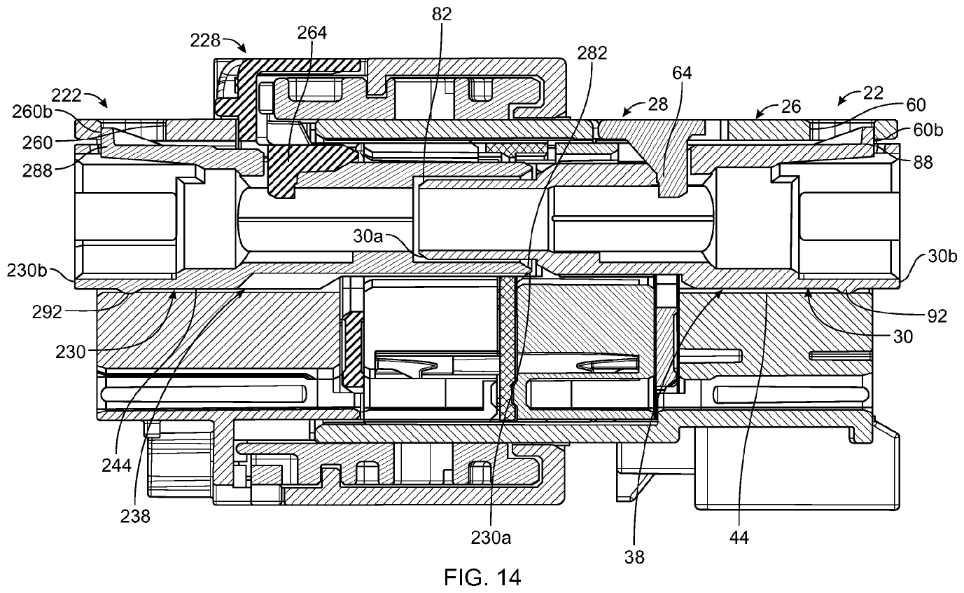

During mating, the front portion 66a of the male module 30 is pushed into to seat within the passageway 278 of the female module 30 as shown in FIGS. 13 and 14. If the central axes of the modules 30, 230 are not aligned when the male connector 22 being inserted into the female connector 222, the modules 30, 230 rotate around the appropriate nub(s) 90, 92, 94, 96, 290, 292, 294, 296 until the central axes of the modules 30, 230 align. This allows for a proper insertion of the male module 30 into the female module 230 so that the terminals therein properly mate. The chamfer 82 assists in the entry and centering of the front end 30a of the male module 30 through the front end 230a of the female module 230 by engagement with the chamfer 282 of the female module 230. The electrical terminals positioned within the terminal receiving passageways 40 of the male connector 22 electrically couple to the electrical terminals positioned within the terminal receiving passageways 240 of the female connector 222, and the electrical terminal positioned within the male module 30 electrically couples to the electrical terminal positioned within the female module 230. Once the male and female connectors 22, 322 are coupled, the independent secondary locks 28, 228 are moved relative to seat the projections 64, 264 within the openings 102, 302, and the connector position assurance device 232 and slider 234 are engaged.

While the modules 30, 230 are shown as entering from the rear 26a, 226a of the male housing 26, 226 with latches 84, 284 that accommodate this rear entry, the housings 26, 226 can be modified to allow for a front entry through the front ends 26a, 226a with the latches 84, 284 which can be reversed or modified to allow for this entry. In addition, while the latches 84, 284 are described as being on a single wall, latches may be provided on more than one wall. While the projections 98, 298 are shown as fixed members extending from the walls 74, 76, 274, 276 the projections 98, 298 may be formed as parts of depressible latches. In addition, the projections 98, 298 may be formed on the top and bottom walls 70, 72, 270, 272 and the recesses 52, 252 into which the projections 98, 298 accordingly repositioned.

While a particular embodiment is illustrated and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and the appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims. Further, the foregoing descriptions describe methods that recite the performance of a number of steps. Unless stated to the contrary, one or more steps within a method may not be required, one or more steps may be performed in a different order than as described, and one or more steps may be formed substantially contemporaneously. Finally, the drawings are not necessarily drawn to scale.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A high-speed connector system comprising:
a male connector and a female connector, the connectors being configured to be coupled together, wherein each connector comprises:
a housing and a module, the housing being configured to house a plurality of electrical terminals in terminal receiving passageways extending therethrough, the housing further having walls defining a module receiving passage that extends from a front end thereof to a rear end thereof and in which the module is seated, the module having a plurality of walls defining a terminal receiving passageway that extends from a front end thereof to a rear end thereof and is configured to receive an electrical terminal, and a plurality of rounded nubs on the walls of the module which are engaged with the walls forming the module receiving passage and which space the walls forming the module from the walls of the module receiving passage, and
wherein a front end of the module of the male connector seats within the terminal receiving passageway of the female connector when the male and female connectors are coupled.

2. The high-speed connector system of claim 1, wherein each connector further comprises a pair of recesses in opposed walls of the module receiving passage, and a pair of projections extending from opposite walls of the module and forward of the nubs, the projections seating within the recesses and being movable relative thereto.

3. The high-speed connector system of claim 2, wherein a front end of the module of the male connector has a chamfer thereon.

4. The high-speed connector system of claim 3, wherein a front end of the module of the female connector has a chamfer thereon.

5. The high-speed connector system of claim 2, wherein each connector further comprises a stop wall extending into the module receiving passage which restricts the size of the module receiving passage, wherein the stop wall is forward of front ends of the projections and a gap is formed between the stop wall and the front ends of the projections.

6. The high-speed connector system of claim 5, wherein each connector further comprises a depressible latch on the module rearward of the projections thereon, and an opening in the housing which is configured to receive an end of the latch, the opening being larger than the end of the latch.

7. The high-speed connector system of claim 2, wherein each module further has a top wall which has a nub thereon, an opposite bottom wall which has a nub thereon, and opposite side walls, each side wall having a nub thereon.

8. The high-speed connector system of claim 7, wherein the nubs on each module are longitudinally arranged and are proximate to a rear end of the module.

9. The high-speed connector system of claim 1, wherein the nubs on each module are proximate to a rear end of the module.

10. The high-speed connector system of claim 1, wherein the modules are removable from the housings.

11. A connector for a high-speed connector system comprising:
a housing configured to house a plurality of electrical terminals in terminal receiving passageways extending therethrough, and walls defining a module receiving passage that extends from a front end thereof to a rear end thereof; and
a module seated within the module receiving passage, the module having a plurality of walls defining a terminal receiving passageway that extends from a front end thereof to a rear end thereof and is configured to receive an electrical terminal, and a plurality of rounded nubs on the walls of the module which are engaged with the walls forming the module receiving passage and which space the walls forming the module from the walls of the module receiving passage.

12. The connector of claim 11, further comprising:
a pair of recesses in opposed walls of the module receiving passage, and a pair of projections extending from opposite walls of the module and forward of the nubs, the projections seating within the recesses and being movable relative thereto.

13. The connector of claim 12, wherein a front end of the module has a chamfer thereon.

14. The connector of claim 12, further comprising a stop wall extending into the module receiving passage which restricts the size of the module receiving passage, wherein the stop wall is forward of front ends of the projections and a gap is formed between the stop wall and the front ends of the projections.

15. The connector of claim 14, further comprising a depressible latch on the module rearward of the projections thereon, and an opening in the housing which is configured to receive an end of the latch, the opening being larger than the end of the latch.

16. The connector of claim 12, wherein the module has a top wall which has a nub thereon, an opposite bottom wall which has a nub thereon, and opposite side walls, each side wall having a nub thereon.

17. The connector of claim 1, wherein the nubs are proximate to a rear end of the module.

18. The connector of claim 1, wherein the module is removable from the housing.

19. The connector of claim 1, wherein the connector is a male connector.

20. The connector of claim 1, wherein the connector is a female connector.
